(19) United States
(12) Patent Application Publication
(10) Pub. No.: US 2007/0070942 A1
(43) Pub. Date: Mar. 29, 2007

(54) SEMIACTIVE STATE FOR REDUCING CHANNEL ESTABLISHMENT DELAY

(75) Inventors: John M. Harris, Chicago, IL (US); Ronald T. Crocker, St. Charles, IL (US); Sean S. Kelley, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/467,954

(22) Filed: Aug. 29, 2006

Related U.S. Application Data
(60) Provisional application No. 60/721,286, filed on Sep. 28, 2005.

(51) Int. Cl. H04Q 7/00

(52) U.S. Cl. 370/329

(57) ABSTRACT

A method and apparatus for creating a semi-active state that reduces channel establishment delay. A communication channel between a mobile station (402) and a radio access network (RAN) (404). The communication channel has a semi-active state between the mobile station and the RAN by preassigning at least one resource to identify the communication channel. In To determine whether the channel is to be made active, the preassigned resource is monitor. When resource indicates that data is to be sent, the channel is converted from the semi-active state to an active state. Data is then transmitted over the communication channel in the active state.

### FIELD OF THE INVENTION

The present invention relates generally to establishing channels between a mobile station and radio access network and, in particular, creating a semi-active state as a part of channel establishment.

### BACKGROUND

Wireless communications networks use numerous different protocols, such as Code Division Multiple Access (CDMA), Global System for Mobile Communications (GSM), Universal Mobile Telecommunication System (UMTS), Push-to-Talk (PTT) and Push-to-Talk over Cellular (PoC) and others, to effectuate communication between users of mobile stations and other communication devices. In these systems, the communication link from the radio access network (RAN) to the mobile station is typically called the forward link or the downlink. Similarly, the communication link from the mobile station to RAN is typically called the reverse link or uplink. CDMA and other wireless network protocols use medium access control identifiers (MAC IDs) as a part of a means to identify a channel to the mobile station on the forward link. On the reverse link, the mobile stations transmissions are differentiated from one another by scrambling codes. Once a MAC ID and a scrambling code have been identified and exchanged, a dedicated channel is established between the mobile station and the base transceiver stations (BTSs) of the wireless network. With a dedicated channel established, data can be sent directly between the mobile station and the BTS such that when the MAC ID is assigned an active channel is established in which data flows.

One reason to establish a dedicated channel is that certain messaging or user data is too large to fit on shared or common channels. To transfer this data therefore requires establishment of such a dedicated channel. One of the drawbacks of establishing a dedicated channel is that the establishment of the dedicated channel itself can add significant delay. In dispatch communications, such as PTT and PoC, this additional delay can degrade the user experience while using the system.

Known methods of reducing the delay in setting up communication channels comes at the expense of RF capacity and battery life. Such methods speculatively place a user on a channel or use longer RF inactivity timers. RF capacity is reduced because dedicated channels are used before they are needed or longer than they are needed. In addition, prematurely using channels or extending the timer uses valuable battery life that could otherwise be used when data is actually being transmitted between the mobile station and the RAN.

In a typical wireless communication system, a large fraction of the resources dedicated to a given cell is not utilized or is otherwise underutilized. It has been estimated that approximately 70% of calls occur in cells or other sectors that have unused RF resources. It is possible, therefore, to leverage those unused RF resources to reduce the mobile initiated setup delay caused by the current call up routines of CDMA by over 400 msecs while simultaneously not degrading battery life.

It is known in High Rate Packet Data system and IS2000 traffic channel set up procedures to adjust the setup procedures to reduce delay times. In such systems, it is known for the controller to provide for multiple types of modes during the communication channel setup process. These modes can include an active mode, radio environment report (RER) mode and a dormant mode. The active mode permits active data transmission between the mobile station and the RAN, typically on dedicated channels. The RER mode is a mobility tracking mode where the mobile station reports significant changes in its radio environment to the network, typically on common channels. In this mode, the dedicated resources associated with the mobile station, such as the MAC ID, may be released and the mobile station's reverse pilot channel may operate in a reduced mode.

In contrast, a control-hold mode operates as an interim position between the active and dormant mode where the power control or dedicated pilot signaling is sent at a low rate in order to decrease the resource costs associated with a call. In this mode, the link is less effective at actually carrying bearer traffic thereby providing additional latency when data must be exchanged. Thus, resources remain allocated but the average reverse link power is reduced. In other words, the channel still operates but at a reduced capacity. Because the channel is still operating, battery life is compromised.

In view of the foregoing, it is desired to create a method and apparatus that establishes a communication channel that uses underutilized network resources but does not compromise battery life and the like. Such a solution can use the concept of multiple modes to establish a communication channel.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication network illustrating the establishment of a channel according to the prior art.

FIG. 2 is a call flow diagram of a mobile station initiated call set-up routine according to the prior art.

FIG. 3 is a call flow diagram of a radio access network initiated call set-up routine according to the prior art.

FIG. 4 is a block diagram of a wireless communication network illustrating the dormant mode according to the prior art.

FIG. 5 is a block diagram of a wireless communication network illustrating the establishment of a channel made in accordance with the principles of the present invention.

FIG. 6 is a call flow diagram of a mobile station initiated call set-up routine according to the principles of the present invention.

FIG. 7 is a call flow diagram of a radio access network initiated call set-up routine according to the principles of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the use of a semi-active state during the establishment of a channel between a mobile station and a radio access network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for the use of a semi-active state during the establishment of a channel between a mobile station and a radio access network as described herein. The non-processor circuits may include, but are not limited to, a radio receiver, a radio transmitter, signal drivers, clock circuits, power source circuits, and user input devices. As such, these functions may be interpreted as steps of a method to perform the use of a semi-active state during the establishment of a channel between a mobile station and a radio access network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A system and method that creates a semi-active state during the establishment of a channel between a mobiles station and a wireless network, such as a RAN, is described. The approach described reduces the delay time in the request for a channel, the establishment of the channel and the sending of data over the channel. The use of the semi-active state also leverages resources within the wireless network that are otherwise not used without degrading the battery life of the mobile station. Such wireless networks include, but are not limited to, Code Division Multiple Access (CDMA), Global System for Mobile Communications (GSM), Universal Mobile Telecommunication System (UMTS), Push-to-Talk (PTT), Push-to-Talk over Cellular (PoC), wireless local area networks (WLANs) and networks that follow 802.xx standards, such as 802.16.

In at least one embodiment of the present invention, the channel is established between the mobile station and the wireless network or RAN by pre-assigning the mobile station a resource or other type of channel identifier without utilizing the resource to send data between the mobile station and the RAN. A MAC ID or reverse scrambling code can be used as the resource to identify the communication channel. By identifying the channel while not sending data, the semi-active state is established and the channel is ready for data transmission at the appropriate time. The semi-active state is a quasi sleeping state where the communication channel between the mobile station and the RAN is known and ready for use but some network resources previously utilized in the active mode are not utilized so that running capacity and battery life are not compromised.

On the forward link, the mobile station monitors the MAC ID for the transmission of data that is sent from the RAN to the mobile station. The mobile station is sent information and packets labeled by the MAC ID to differentiate information and packets sent to other mobile stations communicating with the RAN. Once the channel has been fully activated, the forward link sends power control information indicating whether the mobile station should power up or power down on the reverse link. In some cases, the mobile station receives from the RAN on the forward link acknowledgment/negative acknowledgments indicated whether or not the mobile's transmission was correctly received.

On the reverse link, the reverse scrambling code identifies the channel and is monitored by a reverse link dedicated channel element modem at the base transceiver sites of the RAN. The scrambling code for a given mobile station is typically assigned to a mobile station, either permanently or temporarily. When temporarily assigned, this is typically done through communication between the mobile station and the base station. The present invention does not impact the means for establishing or exchanging the scrambling code. On the reverse link, the mobile transmits the reverse pilot channel and the reverse data rate control using the scrambling code. The reverse pilot channel is a known signal used to assist in receiving any other channels transmitted by the mobile station and is used by the base station to determine power control for the mobile station transmissions. The data rate control channel carries channel quality information. In the past, a modem was only allocated to a mobile station when the mobile station was actually on the dedicated channel and actually transmitting on the reverse link. In accordance with the principles of the present invention, however, the modem is dedicated to monitor the reverse link before the mobile station begins transmitting on the dedicated channel.

As will be appreciated by those of skill in the art, in the active state voice and non-voice data can be sent over the channel between the mobile station and the RAN. Such communication can be both on the forward link and the reverse link. When the data transmission is detected on the reverse link, data rate control and power and pilot data are sent to convert the channel from the semi-active state to the active state. In at least one embodiment, the channel becomes active when the transmitted data rate control and power data reaches a given threshold, where such threshold is a maximum power rate. In an alternate embodiment, the channel becomes active when the RAN sends data at a wake-up interval for the assigned resource.

In one embodiment of the present invention, the mobile station initiates the establishment of the channel when the mobile station has data to send to the RAN on the reverse link using the reverse scrambling code. The network has pre-established the semi-active channel with the mobile unit, identifying and exchanging the MAC ID and the reverse scrambling code for the channel. The mobile station initiates the use of the semi-active channel when there is data to be sent to the RAN, such as when a call is being made. The RAN is monitoring the reverse scrambling code, which can be monitored by the reverse dedicated channel element at the RAN, to determine if the mobile station is sending data. The RAN monitors the power level received on the reverse dedicated power/pilot data or the reverse data rate control channels. When a threshold value is reached, the network begins transmitting to the mobile over the MAC ID including sending power control bits to the mobile. In one embodiment, a threshold number of power down messages is used to indicate that the RAN has detected the mobile station's initiation of using the channel. Thereby, the channel is effectively moved from the semi-active state to an active state so that data is transmitted between the mobile station and the RAN.

In another embodiment of the present invention, establishment of the channel by utilization of the semi-active channel is initiated from the RAN to the mobile station. Data transfer between the RAN and the mobile station can occur at given intervals. One such interval is the wake-up interval and that is when the mobile station will “wake-up” and listen to see if the RAN is establishing an active channel. At the wake-up interval the RAN sends the mobile station a packet using the MAC ID to indicate that the semi-active channel will be utilized and data will be sent. The mobile station will begin to send reverse data rate control and reverse dedicated pilot and power data. The RAN then monitors the power received on the reverse link and on the reverse dedicated power/pilot data or reverse data rate control channels.

Turning to FIG. 1, a block diagram of a wireless communication system 100 illustrating an example from the prior art to establish a channel between a mobile station 102 and a wireless network such as radio access network (RAN) 104 is shown. Mobile station 102 operates so as to be communicatively coupled to RAN 104 and in particular to any of the Base Transceiver Sites (BTSs) 106, 108. The mobile station 102 may be any type of wireless device. For instance, mobile station 102 may be a cellular telephone, pager, personal computer or personal digital assistant. Other examples of mobile stations are possible. The RAN 104 includes equipment that enables the mobile station 102 to communication with the BTSs 106, 108 and other elements of the system. For example, the BTSs 106, 108 may include transmitters and receivers that allow communications to be transmitted and received between the RAN and the mobile station. In particular, the BTSs 106, 108 include a transceiver or modem 109. A RAN 104 may include Base Station Controller (BSC) 112, operably coupled with the BTSs 106, 108. Further, the RAN 104 communicates with the Packet Control Function 114 and the Packet Data Switching Node (PDSN) 116 to relay data between the mobile station 102 and the internet 118.

The system 100 may operate according to any number of protocols, including but not limited to CDMA and UMTS. For instance, messages may be exchanged between the system elements according to the Session Initiation Protocol (SIP). However, it will be understood that other protocols or SIP-compliant protocols may be used in addition or in place of the SIP protocol.

The BTSs 106, 108 are connected to the BSC 112. The BSC 112 is responsible for controlling operation of the BTSs 106, 108 and for routing communication between the BTSs 106, 108 and the other network elements, such as the Packet Control Function (PCF) 114. Further, the BSC 112 is responsible for identifying calls where the semi-active state is being utilized or can be utilized. It will be realized, however, that although these functions are described herein as being implemented at the BSC 112, the function can be alternatively be implemented at other elements within the infrastructure, including but not limited to the BTSs 106, 108 or the PCF 114.

The PCF 114 is connected to the RAN 104 and the Packet Data Server Node (PDSN) 116. The PCF is responsible for maintaining the connection between the mobile station 102 and the PDSN 116 as the connection between the mobile station 102 and the RAN 104 moves among the various modes and states as discussed above.

The PDSN 116 is connected to the PCF 114 and the Internet 118. The PDSN 116 routes packets between the Internet 118 and the mobile station 102 via the PCF 114, and performs other functions such as accounting and security.

Communication between the RAN 104 and the mobile station 102 is accomplished through channels. There are two classes of channels: dedicated channels and common channels. These channels are as described earlier in this specification.

When a dedicated channel 122 is established using the wireless communication network shown in FIG. 1, both a forward dedicated channel 123 and reverse dedicated channel 125 are established. A MAC ID is assigned to the forward dedicated channel 122, which is established between the BTSs 106, 108 and the mobile station 102 by the BSC 112 and the PCF 118. The MAC ID is a known resource used to identify the communication channel to the mobile station 102 from the RAN 104. Other resources can be used as a communication channel identifier. Prior to establishment of the channel, a reverse scrambling code is assigned to the mobile station 102. The BTSs 106, 108 use the known reverse scrambling code assigned to the mobile station 102 to associate transmissions from the mobile station 102 to the RAN 104. With the assigned reverse scrambling code, the mobile station 102 can send data rate control 124 and reverse dedicated pilot 126 to the RAN, specifically to the BTSs 106, 108. The BTSs 106, 108 use the data rate control 124 to choose parameters for data transmission on the forward link to mobile station 102 utilizing the MAC ID.

When the mobile station 102 and RAN 104 communicate when no dedicated channel 122 is established, they do so using common channels 130. The common channels include a forward control channel 132 and a reverse access channel 134. The forward control channel 132 is used by the RAN 104 to send messages to the mobile station 102 when no dedicated channel is established, such as the case when various control messages are sent from the RAN 104 to the mobile station 102. The reverse access channel 134 is used by the mobile station 102 to send messages to the RAN 104 when no dedicated channel is established, such as the case when various control messages are sent from the mobile station 102 to the RAN 104.

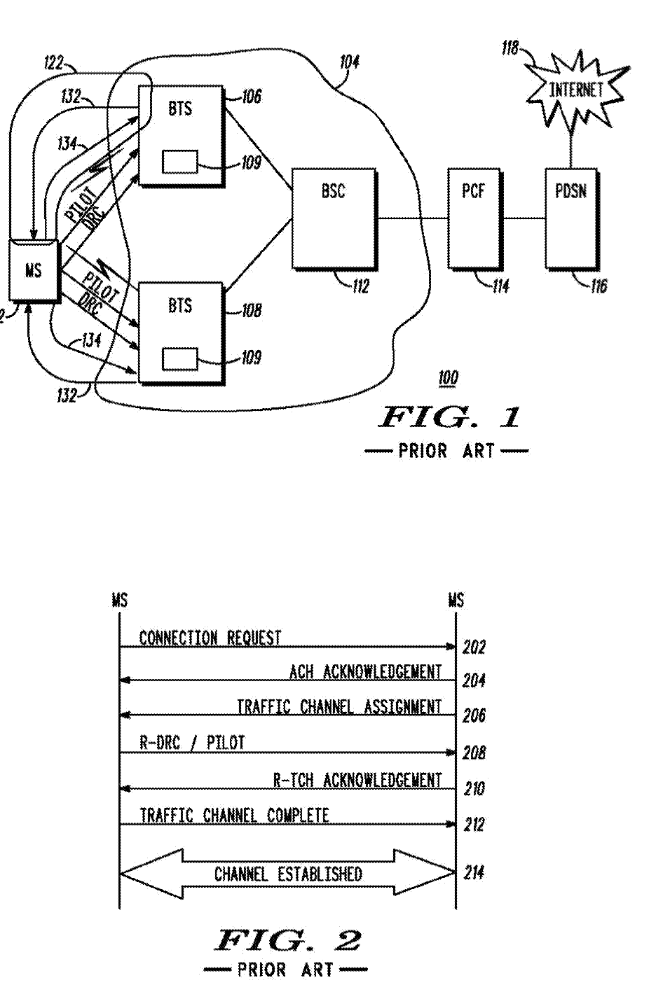

Turning now to FIG. 2, the steps of the call flow 200 establishing the channel 122 when initiated by the mobile station 102 of the prior art shown in FIG. 1 are described. The call flow begins with the mobile station sending 202 to the RAN 104, by way of the BTSs 106, 108 a connection request message on the reverse access channel 134. The connection request message includes the reverse scrambling code for the mobile station 102 or sufficient information for the RAN 104 to infer the reverse scrambling code for the mobile station 102. In response, the BTSs 106, 108 return 204 an access channel acknowledgement message to the mobile station 102 by way of the forward control channel 132 indicating that the request has been received. In response to the connection request message, the BTSs 106, 108 also send 206 a traffic channel assignment (TCA) message, including the assigned medium access control identifier (MAC ID). With the assignment of the MAC ID, the mobile station starts to send 208 the reverse data rate control (R-DRC) 124 and the reverse dedicated pilot 126 to the BTSs 106, 108. In response to successfully receiving and decoding the R-DRC 124 and reverse dedicated pilot 126, the BTSs 106, 108 send 210 a Reverse Traffic Channel ACK (RTCAck) message. Upon receipt of the RTCAck message, the mobile station sends 212 a Traffic Channel Complete (TCC) message. At this point, the dedicated channel is established in both directions and either the mobile station 102 or RAN 104 can send data 214. The time between the sending of the connection request in 202 to the sending of the TCC message in 212, indicating that the channel has been completely set up, can be approximately 500 msecs. As described below, one of the objectives of the present invention is to reduce that delay between channel set up and the sending of data.

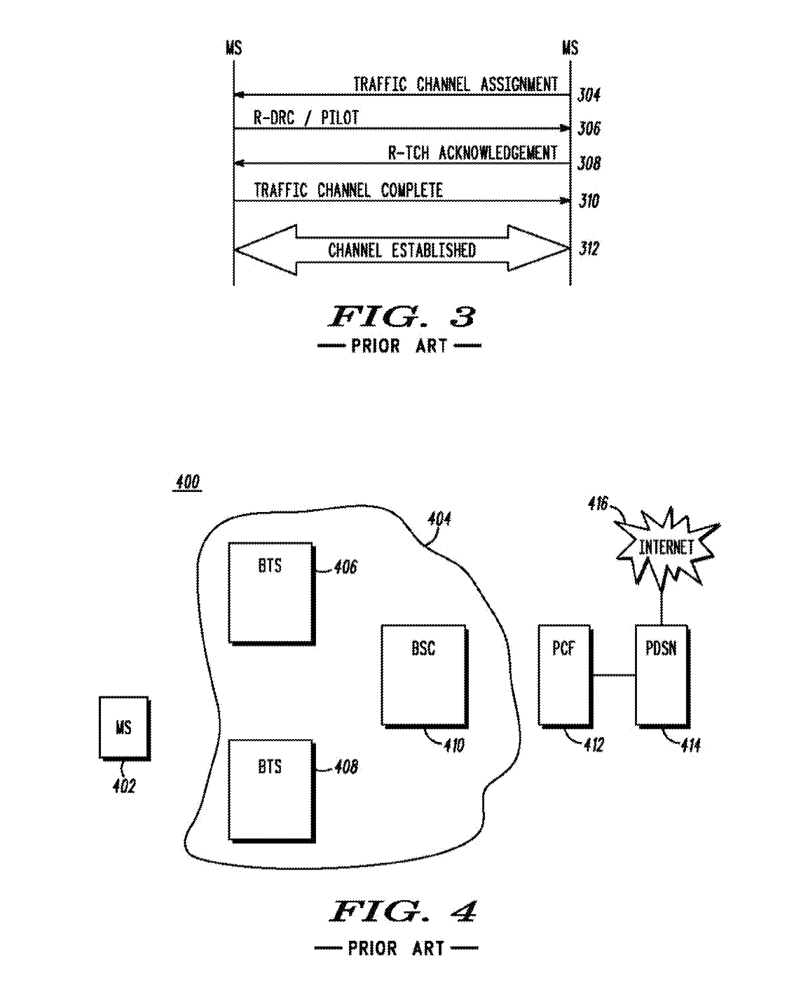

Turning now to FIG. 3, the steps of the call flow 300 establishing the channel 122 when initiated by the RAN 104, e.g. the forward link, of the prior art shown in FIG. 1 are described. The call flow begins with the RAN, by way of the BTSs 106, 108, sending 302 to the mobile station 104 a message during a given time slot, such as at the wake-up interval. There is a delay between the time that the BTSs are prepared to send data to the mobile stations and the slot cycle associated with the wake-up interval. This message can take the form of a Page message or a Traffic Channel Assignment (TCA) message. In the case of the RAN sending a Page message, the mobile station will follow the procedure as described in FIG. 2 after receiving the Page message; as such, this figure describes the case when the message takes the form of a TCA message. During the wake-up interval, the BTSs 106, 108 send 304 the TCA message to assign a MAC ID to the channel. With the assignment of the MAC ID, the mobile station starts to send 306 R-DRC 124 and reverse dedicated pilot 126 to the BTSs 106, 108. In response to the R-DRC 124 and reverse dedicated pilot 126, the BTSs 106, 108 send 308 a Reverse Traffic Channel Acknowledgement (R-TCH Ack) message. When the mobile station receives the R-TCH Ack message, it sends 310 the Traffic Channel Complete (TCC) message. At this point, the dedicated channel 122 is established in both directions and either the mobile station 102 or RAN 104 can send data 312. The time between the sending of the TCA message in 304 to the completion of the channel being set up and data being sent 312 from the BTSs 106, 108 to the mobile station 102 can be approximately 400 msecs, which does not include the delay caused by the waiting for the wake-up interval. As described below, one of the objectives of the present invention is reduce that delay between channel set up and the sending of data.

FIG. 4 illustrates a wireless communication network 400 of the prior art operating in a dormant mode between the RAN 404 and mobile station 402. Like network 100, network 400 includes a mobile station 402, a RAN 404, a PCF 412 and PDSN 414. Likewise, RAN 404 includes BTSs 406 and 408. When operating in the dormant mode, the connection between the PCF 412 and PDSN 414 is maintained and the relationship between the mobile station 402 and the PDSN 414 is also maintained, but the complete connection between the mobile station 402 and the PDSN 412 is not maintained. This is illustrated in the figure as the lack of lines connecting the PCF 412, BSC 410, and BTSs 406 and 408, and the lack of a modem/transceiver in the BTSs corresponding to the modem/transceiver 109 in network 100. The principal benefit of operating in the dormant mode is that packets arriving at the PDSN 414 destined for mobile station 402 can be delivered by first relaying those packets to the PCF 412 which causes the RAN 404 to request that mobile station 402 be returned to the active state (using a procedure such as that shown in FIG. 3) and then there is a path by which the packets can be delivered to the mobile station 402.

When the packet arrives at the PDSN 414 it relays that packet to the PCF 412. Because the PCF 412 is operating in dormant mode, it will request that the RAN 404 return the mobile station 402 to the active mode. One such way the RAN 404 can return the mobile station 402 to the active mode is to follow the routine as described in FIG. 3. Once the mobile station 402 is in the active mode, the packet is relayed by the PCF 412 to the RAN 404 for delivery over the communication channel to the mobile station 402.

FIG. 5 illustrates a wireless communication network 500 operating in accordance with the principles of the present invention. Like network 100 and network 400, network 500 includes a mobile station 502 and a RAN 504. RAN 504 includes BTSs 506, 508, modem/transceiver 509, BSC 510, PCF 512 and PDSN 514, all of which perform the same functions as their counterparts in network 100. In an embodiment of the present invention, the semi-active channel is set up between the mobile station 502 and the BTSs 506, 508. When the semi-active channel is established, as described below, a channel is set up by pre-assigning a MAC ID to the mobile station 502 and pre-exchanging the scrambling code from the mobile station to the RAN 504, but no data, e.g. voice and non-voice data, is sent between the mobile station 502 and the RAN 504. Thus, the semi-active channel provides the mobile station 502 and the RAN 504 the means to know the necessary resources for the channel when data is ready to be sent on the forward link or reverse link without having to go through the process of setting up the channel as described above. For example, once the MAC ID is assigned, the semi-active channel does not send DRC and pilot signal from the mobile station 502 to the BTSs 506, 508. As no data is being sent, the connection between the BTSs 506, 508 and the BSC 510, and PCF 512 are also semi-active and not utilized. The semi-active state of the communication channel is indicated in FIG. 5 with a dashed line.

As stated, the semi-active state is created by allocating a MAC ID, reverse scrambling code or other identification resource to a communication channel between the mobile station 502 and the RAN 504. With the identification resource allocated to the channel, there is no need to maintain the channel by sending data over the channel that will adversely affect the mobile station 402, e.g. draw on battery life, or affect the RF for the mobile station 502 or other mobile stations within the network. The MAC ID is assigned to a channel by the traffic channel assignment (TCA) message. A scrambling code can be used to identify the reverse link channel. It will be appreciated by those of ordinary skill, that other known features can be used to identify the channel while maintaining the semi-active status of the channel by not sending data between the mobile station and the RAN.

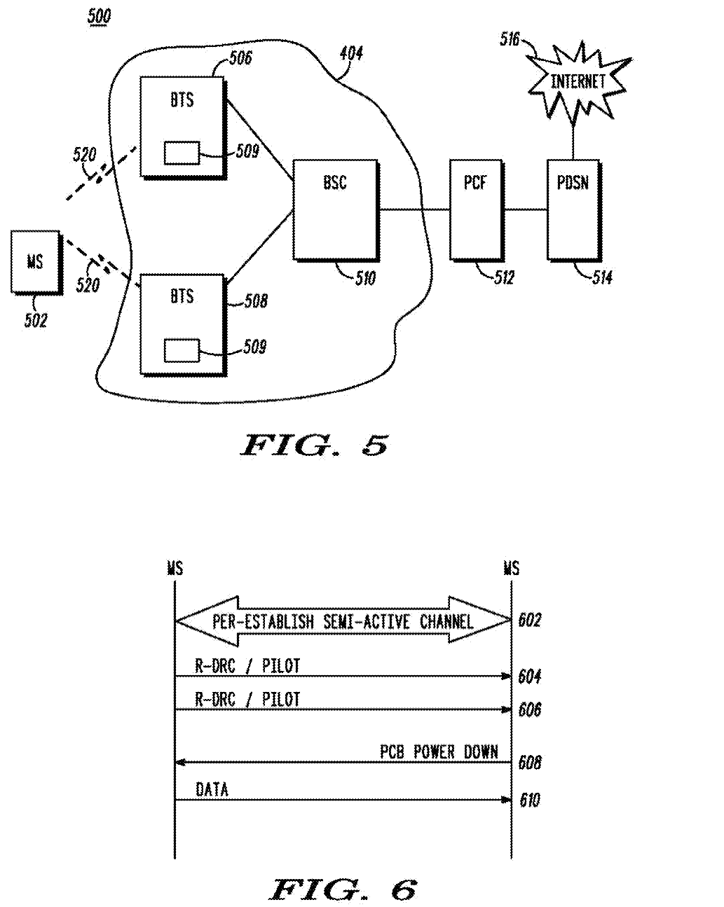

FIG. 6 shows a call flow diagram 600 of a utilization of a communication channel in the semi-active state of the present invention from the perspective of the mobile station 502. According to the principles of the present invention, the communication channel in the semi-active state is pre-established 602 between the mobile station 502 and RAN 504 some time prior to the mobile station 502 intending to send data, either control data associated with the radio system or user data intended for delivery through the RAN 504 to the PCF 512 and PDSN 514. With the semi-active channel, the MAC ID is already assigned and the channel is ready to send data, and when the data arrives in the RAN 504 it is capable of processing that data internally or routing that data through the PCF 512 to the PDSN 514. When the mobile station 502 is ready to send data on the reverse link, the semi-active channel is converted to an active channel so that voice and non-voice data can be sent. To do so, the mobile station 402 starts to transmit 604 the R-DRC and reverse pilot signal at given intervals using the reverse scrambling codes, with the power increasing on subsequent transmissions. The increases continue 606 until the RAN 504 detects a threshold value and sends 608 a power control bit (PCB) power down message. With the power down message, the mobile station 402 is informed that R-DRC and reverse pilot signal levels are sufficient to send data over the channel. Once the channel is activated, an acknowledgment/negative acknowledgment channel is activated which provides feedback to the mobile station indicated which of its transmissions were successfully received. Data can then be sent 610 between the mobile station 502 and the RAN 504. Without having to send the connection request messages, the TCA messages and the various acknowledgements described in relation to FIG. 2, the call routine of the present invention can reduce call set up delay up to 600 msecs. As there is no data being sent after the resources are allocated to designate the existence of the communication channel, the time savings does not compromise the battery life or other features of the mobile station nor does it affect the RF of the RAN. In another embodiment of the present invention, the data can be transmitted concurrent with the transmission of the R-DRC and reverse pilot signal 604.

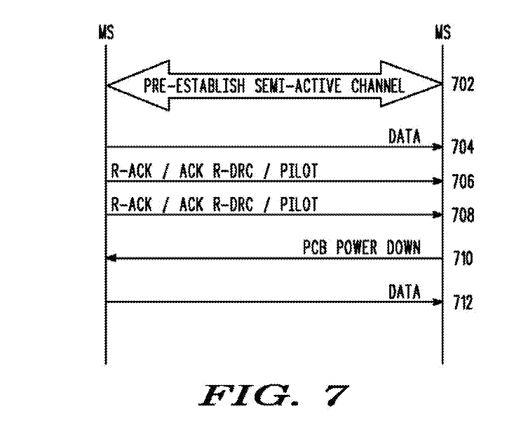

FIG. 7 shows a call flow diagram 700 of a channel assignment and utilization of the semi-active state of the present invention for initiation from the perspective of the RAN 504 on the forward link. According to the principles of the present invention, the semi-active channel is pre-established 702 between the BTSs 506, 508 and the mobile station 502. When the RAN 504 is ready to complete the forward link channel with the mobile station 402, the data is sent 704 at a designated point in time. In one embodiment, the designated time is the wake-up interval when the mobile station 502 is expecting to receive data from the RAN 504. In response to receiving data, the mobile station 502 starts to transmit the reverse acknowledgement (R-ACK) channel, the reverse DRC and pilot signal, with the power increasing on subsequent transmissions. The increases continue 708 until the RAN 504 detects a threshold value and sends 710 a PCB power down message thereby indicating that the R-DRC and reverse pilot signal is sufficient to send data over the channel. Data can then continue to be sent 712 between the mobile station 502 and the RAN 504.

In an alternate embodiment, the RAN 504 can send data on the forward link that is detected by the mobile station 502 at a predetermined data rate. When the mobile station detects the designated data rate over the semi-active channel, the channel is converted to an active channel as described. Without having to send the connection request messages, the TCA messages and the various acknowledgements described in relation to FIG. 3, the call routine of the present invention can reduce call set up delay up to 400 msecs, without considering the delay waiting for the next wake-up interval. As there is no data being sent after the resources are allocated to designate the existence of the communication channel, the time savings does not compromise the battery life or other features of the mobile station nor does it affect the RF of the RAN.

In an alternate embodiment of the present invention, at least one resource is allocated for use by a communication channel between the mobile station 502 and the RAN 504. This resource is preassigned to the channel so that either the mobile station 502 or the RAN 504 can utilize the allocated resource to refer to the channel. As the resource is preassigned, voice and non-voice data is not being sent between the mobile station 502 and the RAN 504, but when such data is detected or it is otherwise determined that data is being sent between the network elements, the channel is ready to transmit the data. The determination that data is to be transmitted can be achieved by monitoring network resources such as MAC IDs, reverse scrambling codes etc. When the monitoring activities indicate data transmission, the preassigned resource indicates the communication channel between the mobile station 502 and the RAN 504 that will be activated and over which the data will be transmitted. The transition between having a preassigned resource to designate the channel over which no data is transmitted and an active channel is described above. As will be appreciated, data transmission can be initiated from either the mobile station 502 or RAN 504 using the preassigned resource to designate the channel.

For a preassigned resource of the channel or the semi-active channel, an overhead channel can be used to transmit data between the mobile station and the RAN. As a part of the transition to utilize the communication channel to transmit data, such as converting the semi-active channel to an active channel, the overhead information is transmitted over the overhead channel. Such overhead information include RDRC data, increasing power up messages, power down messages and threshold messages to indicate to indicate that data will be properly transmitted over the communication channel.

A resource can be preassigned or a semi-active channel can be formed at any time depending on given resources. In some cases, particularly in areas where network resource are not fully utilized, a resource can be preassigned and a semi-active channel established whenever a mobile station 502 is in the area of a RAN 504. As the mobile station 502 moves within a wireless communication network, different semi-active channels can be established as a part of the soft hand off process between cells. In areas where the network resources are more fully utilized, not all mobile stations can be preassigned a resource because there are not enough the limited resources for all the mobile stations. Thus, criteria such as expiration of the mobile station's inactivity timer, accessing a phone book, opening a phone, dialing a number etc. will cause the mobile station 504 to request the preassignment of the resource. From the RAN's perspective similar criteria can be used to create the semi-active channel. Alternatively, the semi-active state is particularly appropriate for the subset of mobile stations that are most likely to send or receive a call shortly. The subset of users may be identified as users that had very recently made a call as a call may have been dropped. Additionally, the network may specifically select the subset of users or mobile stations with lower mobility or less than a threshold amount of handoffs because users which are mobile generate more load. When a mobile station is in the semi-active state, or switches from one BTS or sector to another, some messaging is exchanged over the common channel so the network can assign a new MAC ID in its new BTS. Thus, a highly mobile semi-active user uses more resources than stationary semi-active user.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of establishing a wireless communication channel between a mobile station and a wireless network comprising:
preassigning at least one resource to identify the communication channel while not transmitting data over the channel;
informing the mobile station of the resources;
monitoring the use of the resources to indicate transmission of data over the communication channel, and
transmitting data over the communication channel after the resources indicate that the there is to be transmission of data over the communication channel.

2. The method according to claim 1 wherein monitoring includes monitoring for the use of a medium access control identifier (MAC ID) preassigned as at least one of the resources.

3. The method according to claim 1 further comprising:
determining to transmit data from the mobile station to the wireless network;
transmitting a code from the mobile station to the wireless network, wherein the code was preassigned as at least one of the resources;
detecting the use of the code by the wireless network;
creating the channel between the wireless network and the mobile station upon detection of the use of the code, and
receiving data at the wireless network transmitted from the mobile station.

4. The method according to claim 3 further comprising:
transmitting at least one overhead channel from the mobile station to the wireless network;
monitoring at the mobile station the overhead information including at least one of a power up message and a power down message;
increasing the power level of the transmitted overhead channel;
detecting a threshold number of power down messages in the overhead information, and
transmitting data from the mobile station to the wireless network on the communication channel when the threshold number is detected.

5. The method according to claim 4 wherein the overhead channel includes at least one of a reverse pilot channel, a reverse data rate control channel and a reverse acknowledgement channel.

6. The method according to claim 1 further comprising:
determining to transmit data from the wireless network for transmission to the mobile station;
transmitting the data by the wireless network using a MAC ID as at least one of the resources, and
receiving the MAC ID and the data at the mobile station.

7. The method according to claim 6 wherein transmitting data by the wireless network includes transmitting data a pre-determined rate.

8. The method according to claim 6 wherein transmitting data by the wireless network comprising:
identifying a wake-up interval time to transmit data to the mobile station;
waiting for the identified wake-up interval, and
transmitting data to the mobile station at the identified wake-up interval.

9. The method according to claim 1 wherein the wireless network comprises a radio access network.

10. An apparatus for establishing a wireless communication channel comprising:
a resource to identify the communication channel while not transmitting data over the communication channel;
a monitor to detect the use of the resource to indicate that the data is to be transmitted over the communication channel;
a transmitter to send data over the communication channel after the monitor detects that data is to be transmitted over the communication channel.

11. The apparatus according to claim 10 wherein the resource is a MAC ID.

12. The apparatus according to claim 10 wherein the resource is a code preassigned to the communication channel and further comprising a modem to determine the use of the code to create the channel.

13. The apparatus according to claim 12 further comprising:
an overhead channel;
a power up message transmitted over the overhead channel;
a power down message transmitted over the overhead channel, and
a threshold value,
wherein the overhead channel includes increased power up messages until the apparatus sends a power down message when the threshold value is reached.

14. The apparatus according to claim 13 wherein the overhead channel includes at least one of a reverse pilot channel, a reverse data rate control channel and a reverse acknowledgement channel.

15. The apparatus according to claim 10 further comprising a wake-up interval wherein the transmitter transmits data at an identified wake-up interval.

16. A method of establishing a communication channel between a mobile station and a wireless network comprising:
creating a semi-active state between the mobile station and the wireless network by assigning at least one resource to identify the communication channel;
monitoring the at least one resource to determine if data is to be transmitted over the communication channel;
detecting that the at least one resource indicates that data is to be sent;
converting the state of the communication channel from the semi-active state to an active state, and
transmitting data over the communication channel in the active state.

17. The method according to claim 16 further comprising:
determining to transmit data from the mobile station to the wireless network;
transmitting a code from the mobile station to the wireless network;
detecting the use of the code by the wireless network, and
receiving data at the wireless network transmitted from the mobile station.

18. The method according to claim 17 further comprising:
transmitting at least one overhead channel from the mobile station to the wireless network;
monitoring at the mobile station the overhead information including at least one of a power up message and a power down message;
increasing the power level of the transmitted overhead channel;
detecting a threshold number of power down messages in the overhead information, and
transmitting data on the communication channel when the threshold number is detected.

19. The method according to claim 18 wherein the overhead channel includes at least one of a reverse pilot channel, a reverse data rate control channel and a reverse acknowledgement channel.

20. The method according to claim 16 further comprising:
receiving data by the wireless network for transmission to the mobile station;
transmitting the data by the wireless network using a MAC ID as at least one of the resources, and
receiving the MAC ID and the data at the mobile station.

21. The method according to claim 20 wherein transmitting data by the wireless network includes transmitting data a pre-determined rate.

22. The method according to claim 21 wherein transmitting data by the wireless network comprising:
identifying a wake-up interval time to transmit data to the mobile station;
waiting for the identified wake-up interval, and
transmitting data to the mobile station at the identified wake-up interval.

23. The method according to claim 16 wherein the wireless network comprises a radio access network.
